(19) United States
(12) Patent Application Publication
(10) Pub. No.: US 2007/0192123 A1
(43) Pub. Date: Aug. 16, 2007

(54) Process and device for authentication and/or identification

(75) Inventors: Zbigniew Sagan, Rueil-Malmaison (FR); Alain Foucou, Rueil-Malmaison (FR); Jean-Pierre Massicot, Rueil-Malmaison (FR)

Correspondence Address: YOUNG & THOMPSON, 745 SOUTH 23RD STREET, 2ND FLOOR, ARLINGTON, VA, 22202, US

(73) Assignee: ATT-ADVANCED TRACK & TRACE, RUEIL-MALMAISON (FR)

(21) Appl. No.: 11/589,080

(22) Filed: Oct. 30, 2006

(30) Foreign Application Priority Data
Oct. 28, 2005 (FR) 0511100
Oct. 28, 2005 (FR) 0511101

(51) Int. Cl. G06Q 99/00

(52) U.S. Cl. 705/1

(57) ABSTRACT

The authentication process for a group of products includes, for each product: a step for marking the product to produce a mark representative of a first content and, a step of associating a data carrier to the product, the data carrier bearing an item of information representing, firstly, the first content and, secondly, a key specifically assigned to the product in the group of products, the representative item of information being, as a result, different for each product of the group.

This invention concerns a process and a device for authentication and/or identification. It applies, in particular, to the protection against the counterfeiting of marks, distinctive symbols and the products that bear them.

There are already code systems that use watermarking techniques, which allow copyright verification information to be concealed in an image in order to detect unlawful copying of the image. For economic reasons, the coded information is the same for all the lawful copies of the image. These copies cannot, therefore, be identified or individualized.

There are also marking systems on the production line, for example ink-jet printers that make it possible to individualize and date products bearing the marks or distinctive symbols to be defended.

In these two cases, a copy of the image or the mark allows the authentication elements to be copied and does not therefore protect against counterfeiting via servile copying.

The aim of this invention is to remedy these inconveniences. To this end, according to a first aspect, the present invention envisages an authentication process for a group of products, characterized in that it comprises, for each product:

a step of marking said product to produce a mark representative of a first content and

a step of associating a data carrier to said product, said data carrier bearing an item of information representing, firstly, the first content and, secondly, a key specifically assigned to said product in said group of products, said representative item of information being, as a result, different for each product of said group.

Thanks to these provisions, the information, different for each product, makes it possible to ensure the traceability of the product whose label may have been copied. In addition, the data carrier makes the information accessible even if the mark has been damaged by its copying. Finally, the re-importing of products lawfully put on sale, in parallel to the authorized commercial network, may be detected and its origin may be determined thanks to the product's traceability.

Thus, an additional level of security is provided by the link, or correlation, between the mark's content and the information carried by the data carrier authenticating the mark, and makes them indissociable.

According to particular features, the process as described in brief above comprises a coding step prior the marking step, a coding step during which a message representative of the product is coded in said first content.

Thanks to these provisions, the mark representative of the first content may be read and an item of information may be decoded by the lawful owners of this mark, in order to determine the origin or the route followed by the product (authenticity and traceability check).

According to particular features, during the marking step, dots or dashes are constituted in contrast on their background, said dots being representative of the first content.

Thanks to these provisions, the copying of the mark may be detected since, in the case of copying, the size of the dots or dashes or their contrast with the background is altered and the copy may thus be detected.

According to particular features, during the marking step, dots or dashes are constituted on a carrier present on said product. Thanks to these provisions, the mark can be accessed and read by examining said carrier only.

According to particular features, during the marking step, dots are constituted on a separation line of a graphic present on said product.

Thanks to these provisions, the dots do not need to be together in an area that may be unsightly.

According to particular features, during the step of associating a data carrier, a bar code is associated to said product. Thanks to these provisions, the numerous bar code reader devices may be used to read the data carrier.

According to particular features, during the step of associating a data carrier, alphanumeric characters are associated to said product. Thanks to these provisions, reading the data carrier may be carried out automatically, for example, with an OCR (optical character recognition) device or with the naked eye.

According to particular features, during the step of associating a data carrier, a bar code in at least two dimensions is associated to said product. Thanks to these provisions, the quantity of data that may be written in a given carrier is increased compared to the case of the traditional bar code in one dimension.

According to particular features, during the step of associating a data carrier, an electronic tag is associated to said product. Thanks to these provisions, reading the data carrier may be carried out remotely and when the carrier is masked by other products or packaging.

According to particular features, during the association step, a printing operation is carried out via an ink-jet device. Thanks to these provisions, the data carriers may be individualized and unique, for each product or group of products.

According to particular features, during the association step, a printing operation is carried out via laser impact. Thanks to these provisions, the data carriers may be individualized and unique, for each product or group of products and, in addition, their size may be greatly reduced, for example less than the square millimeter.

According to particular features, the association step comprises a step of reading the mark produced during the marking step, and a step of coding said read mark with said code key.

Thanks to these provisions, the information carried by the data carrier may be related to the information carried by the mark, even if the latter has printing faults or is difficult to read.

According to particular features, the association step comprises a step of coding the first content with a unique key specific to said product, each item of information associated during an association step being, as a result, different. Thanks to these provisions, each product may be identified and recognized.

According to particular features, during the marking step, the mark produced comprises error correction codes. Thanks to these provisions, the use of error correction codes needed to read the mark can be measured, which is an indication of the number of copies produced, while it is still possible to access the information initially contained by said mark.

According to a second aspect, the present invention envisages a device for authenticating a group of products, characterized in that it comprises:

a means of marking each product to produce a mark representative of a first content and

a means of associating a data carrier to each product, said data carrier bearing an item of information representing, firstly, the first content and, secondly, a key specifically assigned to said product in said group of products, said representative item of information being, as a result, different for each product of said group.

The advantages, aims and characteristics of the procedure and devices that are the subject of the second aspect of the present invention being similar to those of the process that was the subject of the first aspect of the present invention, they are not repeated here.

In these two cases, a copy of the image or the mark allows the authentication elements to be copied and does not therefore protect against counterfeiting via servile copying.

According to a third aspect, the present invention envisages an authentication process for a group of products, characterized in that it comprises, for each product:

a step of marking said product to produce a mark representative of a first content, said mark being adapted to allow its copying to be detected and

a step of associating a data carrier to said product, said data carrier bearing an item of information representing, firstly, the first content and, secondly, a code key.

Thanks to these provisions, if a servile copy of the mark, for example carried by the product itself, a label it carries or packaging of the product, is performed, the copy may be detected. In addition, the data carrier makes the information accessible even if the mark has been damaged by its copying. Thus, an additional level of security is provided by the link, or correlation, between the mark's content and the information carried by the data carrier authenticating the mark, and makes them indissociable.

According to particular features, the process as described in brief above comprises a coding step prior to the marking step, a coding step during which a message representative of the product is coded in said first content.

Thanks to these provisions, the mark representative of the first content may be read and an item of information may be decoded by the lawful owners of this mark, in order to determine the origin or the route followed by the product (authenticity and traceability check).

According to particular features, during the marking step, dots or dashes are constituted in contrast on their background, said dots being representative of the first content.

Thanks to these provisions, the copying of the mark may be detected since, in the case of copying, the size of the dots or dashes or their contrast with the background is altered and the copy may thus be detected.

According to particular features, during the marking step, dots or dashes are constituted on a carrier present on said product. Thanks to these provisions, the mark can be accessed and read by examining said carrier only.

According to particular features, during the marking step, dots are constituted on a separation line of a graphic present on said product.

Thanks to these provisions, the dots do not need to be together in an area that may be unsightly.

According to particular features, during the step of associating a data carrier, a bar code is associated to said product. Thanks to these provisions, the numerous bar code reader devices may be used to read the data carrier.

According to particular features, during the step of associating a data carrier, alphanumeric characters are associated to said product. Thanks to these provisions, reading the data carrier may be carried out automatically, for example, with an OCR (optical character recognition) device or with the naked eye.

According to particular features, during the step of associating a data carrier, a bar code in at least two dimensions is associated to said product. Thanks to these provisions, the quantity of data that may be written in a given carrier is increased compared to the case of the traditional bar code in one dimension.

According to particular features, during the step of associating a data carrier, an electronic tag is associated to said product. Thanks to these provisions, reading the data carrier may be carried out remotely and when the carrier is masked by other products or packaging.

According to particular features, during the association step, a printing operation is carried out via an ink-jet device. Thanks to these provisions, the data carriers may be individualized and unique for each product or group of products.

According to particular features, during the association step, a printing operation is carried out via laser impact. Thanks to these provisions, the data carriers may be individualized and unique, for each product or group of products and, in addition, their size may be greatly reduced, for example less than the square millimeter.

According to particular features, the association step comprises a step of reading the mark produced during the marking step, and a step of coding said mark with said code key.

Thanks to these provisions, the information carried by the data carrier may be related to the information carried by the mark, even if the latter has printing faults or is difficult to read.

According to particular features, the association step comprises a step of coding the first content with a unique key specific to said product, each item of information associated during an association step being, as a result, different. Thanks to these provisions, each product may be identified and recognized.

According to particular features, during the marking step, the mark produced comprises error correction codes. Thanks to these provisions, the use of error correction codes needed to read the mark can be measured, which is an indication of the number of copies produced, while it is still possible to access the information initially contained by said mark.

According to a fourth aspect, the present invention envisages a process for authenticating a group of products, characterized in that it comprises:

a step of reading an image of a mark,

a step of extracting content from said image to provide a first content,

a step of reading information carried by a data carrier associated to said product,

a step of decoding said information carried by said data carrier to provide a second content and

a step of detecting inconsistencies between the first content and the second content.

According to a fifth aspect, the present invention envisages a device for authenticating a group of products, characterized in that it comprises:

a means of marking each product of said group to produce a mark representative of a first content, said mark being adapted to allow its copying to be detected and

a means of associating a data carrier to said product, said data carrier bearing an item of information representing, firstly, the first content and, secondly, a code key.

According to a sixth aspect, the present invention envisages a device for authenticating a group of products, characterized in that it comprises:

a means of reading an image of a mark,

a means of extracting content from said image to provide a first content,

a means of reading information carried by a data carrier associated to said product,

a means of decoding said information carried by said data carrier to provide a second content and

a means of detecting inconsistencies between the first content and the second content.

The advantages, aims and characteristics of the processes and devices that are the subject of the fourth thru sixth aspects of the present invention being similar to those of the process that was the subject of the third aspect of the present invention, they are not repeated here.

It is noted that the features, fundamental or secondary, of the various aspects of the present invention are intended to be combined together to provide processes and devices presenting the advantages of these various aspects. The principal or particular features of the various aspects of the present invention therefore constitute secondary features of the other aspects of the present invention.

Other advantages, aims and characteristics of the present invention will become apparent from the description that will follow, made, as an example that is in no way limiting, with reference to the drawings included in an appendix, in which:

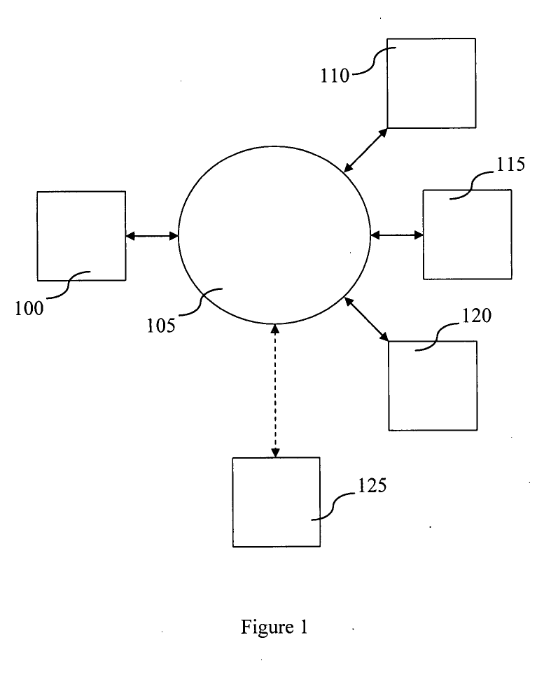

FIG. 1 represents, schematically, a first embodiment of an authentication device that is the subject of this invention,

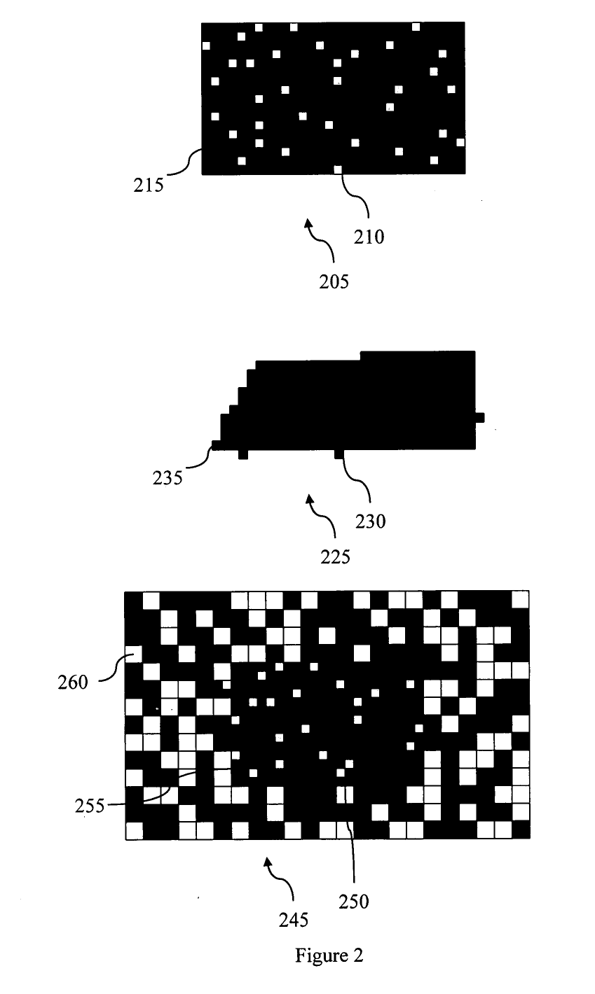

FIG. 2 represents, schematically, a packaging of the product obtained by utilizing a particular embodiment of the process that is the subject of the present invention and

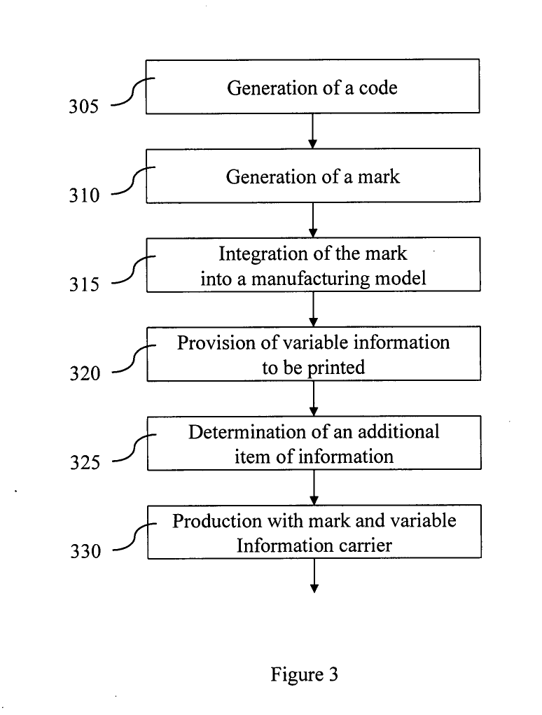

FIG. 3 represents, in the form of a logical diagram, a particular embodiment of the process that is the subject of the present invention.

FIG. 1 shows a code generator server 100, a computer network 105, a rightholder server 110, a local production server 115, a client production serve r 120 and an information reader device 125.

The computer network 105 is a network allowing secured communication, over long distance, between servers equipped with the necessary security tools. For example, the computer network 105 is the Internet network and the protocols utilized comprise the “https” protocol (acronym for HyperText Transfer Protocol Secured), using cryptography.

The generator server 100 is adapted to generate codes whose complexity makes them invulnerable to decoding. For example, these codes utilize key pairs conforming to the PKI (for Public Key Infrastructure) public keys infrastructure. These codes are provided, on request, to the servers of rightholder subscribers such as the server 110. The codes provided represent a first content, of which a part, at least, is for preference provided by the server 110. For example, a code may represent the name of the rightholder, a product reference to be marked and/or a code generation date.

For preference, the product codes comprise error correction codes, for example of the type known under the name “CRC”.

The rightholder's server 110 is adapted to generate, based on the codes supplied by the server 100, marks representative of these codes whose copying can be detected. For example, these marks are incorporated into a geometric shape, for example a rectangle, in the form of contrasted dots or dashes, very small in size, for example white on a black background, whose position is representative of the first content. According to another example, these marks are dots positioned on the edge of a separation line of a graphic, for example a logo, the positions of the dots being representative of the first content. According to another example, these marks are dots or dashes scattered over the surface of the packaging or label of the product, the positions of the dots or dashes being representative of the first content.

For preference, the marks produced comprise error correction codes, for example of the type known under the name “CRC”.

The local production server 115 is adapted to receive the mark representative of the first content from the rightholder's server 110. The local production server is adapted to integrate this mark into the manufacturing model of a product, packaging or label. For example, graphic designers utilize the local production server or a computer system giving access to it to create the model of a product, or a product's label or packaging, with a computer-aided drafting system or a computer-aided design system.

The local production server 115 is also adapted to provide variable information to be printed or marked on said products, packaging or labels. This variable information is intended to identify a product or a batch of products and to be associated to the product being manufactured. This variable information represents, firstly, the first content and, secondly, a code key provided either by the server 100, or the server 110, or the server 115.

The client production server 120 is adapted to receive this model and to control a production chain for the labels and/or packaging comprising a means of printing the mark representative of the first content and a means of associating a data carrier representative of the variable information. For preference, the server 120 utilizes an additional item of information representative of the place of manufacture, the manufacturing order and/or the production date.

The client production server 120 is thus adapted to perform, for each product of a group of products:

a step of marking said product to produce a mark representative of a first content and

a step of associating a data carrier to said product, said data carrier bearing an item of information representing, firstly, the first content and, secondly, a key specifically assigned to said product in said group of products, said representative item of information being, as a result, different for each product of said group.

It is noted that the data carrier may take a number of forms. According to a first example, the data carrier is a bar code associated to the product. According to a second example, the data carrier is a set of alphanumeric characters associated to the product. According to a third example, the data carrier is a bar code in at least two dimensions or a data matrix, known under the name datamatrix, associated to the product. According to a fourth example, the data carrier is an electronic tag, for example of the RFID (acronym for Radio Frequency Identification) type, associated to the product. According to other examples, the data carrier bears biological and/or nanometric tracers.

The data carrier may be printed by an ink-jet printer or may be formed, in the material of the product or packaging, via impact from a pulsed laser beam, for example a laser beam.

In particular embodiments, the mark representative of the first content is read, for example by means of a camera, and, according to the information read, the information carried by the data carrier associated to the product is changed, for example by coding.

For preference, in order to generate the information stored by the data carrier associated to the product, the first content is coded with a unique key specific to the product, each item of information associated during an association step being, as a result, different.

The reader device 125 is adapted to read, firstly, the mark carried by a product and, secondly, the data carrier. For example, it comprises a camera and a lens allowing a picture to be taken of a part of the product or its packaging that carries the mark in question. Working autonomously or in cooperation with the server 100, the reader device is adapted to extract the content from the picture to provide a first content. The reader device 125 is also adapted to read the information carried by a data carrier associated to said product, by means of a camera and/or an electronic tag reader. Working autonomously or in cooperation with the server 115, the reader device 125 decodes the information carried by the data carrier to provide a second content. Finally, the reader device 125 performs an operation detecting inconsistency between the first content and the second content to determine whether the product is authentic, for authentication purposes, or to determine the path, for traceability purposes.

FIG. 2 shows three forms of marks 205, 225 and 245. In mark 205, white dots 210 are positioned in a black rectangle 215 with their positions depending on the first content, possibly including error correction codes.

In mark 225, black dots 230 are positioned on the edge of a graphic 235, here a logo, in positions that depend on the first content, possibly including error correction codes.

In mark 245, white dots 250 are positioned in a black rectangle 255 with their positions depending on the first content, possibly including error correction codes. The rectangle 255 is, in addition, surrounded by a code matrix 260, known under the name datamatrix.

It is noted that, in the aim of linking the matrix code and an authenticator, it is advantageous to have additional bytes (creating an additional field) in the datamatrix code so as to store a control code generated from the content of the central mark and, possibly, to add a variable code to it to individualize the product.

It is noted that, in accordance with this invention, it is possible to utilize dashes or combinations of dots and dashes to constitute the mark or the associated data carrier.

FIG. 3 shows a step 305 of generating a code whose complexity renders it invulnerable to decoding. For example, this code utilizes one key of a key pair conforming to the PKI (for Public Key Infrastructure) public keys infrastructure. For example, a code may represent the titleholder's name, a product reference to be marked and a code generation date. For preference, the product codes comprise error correction codes, for example of the type known under the name “CRC”.

During a step 310, a mark representative of this code is generated, based on the codes supplied during the step 305, whose copying can be detected. For preference, the mark produced comprises error correction codes, for example of the type known under the name “CRC”.

During a step 315, this mark is integrated into the manufacturing model for a packaging or a label.

During a step, 320, variable information to be printed in said labels or packaging is provided. This variable information is intended to identify a product or a batch of products and to be associated to the product being manufactured. This variable information represents, firstly, the first content and, secondly, a code key.

During a step 325, an additional item of information, representative of the place of manufacture, the manufacturing order and/or the production date, is determined.

During a step 330, the labels and/or packaging are produced by printing the mark representative of the first content and associating a data carrier representative of the variable information.

In a variant, the mark is made invisible by selecting a particular manufacturing process, for example locally altering the reflection coefficient of the label or the packaging or utilizing an invisible ink of a known type.

In a variant, the mark is copied in several parts of the packaging.

1-15. (canceled)

16. An authentication process for a group of products, which comprises, for each product:
a step of marking said product to produce a mark representative of a first content and;
a step of associating a data carrier to said product, said data carrier bearing an item of information representing, firstly, the first content and, secondly, a key specifically assigned to said product in said group of products, said representative item of information being, as a result, different for each product of said group.

17. The authentication process according to claim 16, further comprising a coding step prior to the marking step, wherein during said coding step a message representative of the product is coded in said first content.

18. The authentication process according to claim 16 wherein, during the marking step, dots or dashes are constituted in contrast on their background, said dots being representative of the first content.

19. The authentication process according to claim 16 wherein, during the marking step, dots or dashes are constituted on a carrier present on said product.

20. The authentication process according to claim 16 wherein, during the marking step, dots are constituted on a separation line of a graphic present on said product.

21. The authentication process according to claim 16 wherein, during the step of associating a data carrier, a bar code is associated to said product.

22. The authentication process according to claim 16 wherein, during the step of associating a data carrier, alphanumeric characters are associated to said product.

23. The authentication process according to claim 16 wherein, during the step of associating a data carrier, a bar code in at least two dimensions is associated to said product.

24. The authentication process according to claim 16 wherein, during the step of associating a data carrier, an electronic tag is associated to said product.

25. The authentication process according to claim 16 wherein, during the association step, a printing operation is carried out via an ink-jet device.

26. The authentication process according to claim 16 wherein, during the association step, a printing operation is carried out via laser impact.

27. The authentication process according to claim 16 wherein, the association step comprises a step of reading the mark produced during the marking step, and a step of coding said read mark with said code key.

28. The authentication process according to claim 16 wherein, the association step comprises a step of coding the first content with a unique key specific to said product, each item of information associated during an association step being, as a result, different.

29. The authentication process according to claim 16 wherein, during the marking step, the mark produced comprises error correction codes.

30. A device for authenticating a group of products, which comprises:
a means of marking each product to produce a mark representative of a first content and;
a means of associating a data carrier to each product, said data carrier bearing an item of information representing, firstly, the first content and, secondly, a key specifically assigned to said product in said group of products, said representative item of information being, as a result, different for each product of said group.
